(19) United States
(12) Patent Application Publication
(10) Pub. No.: US 2017/0177607 A1
(43) Pub. Date: Jun. 22, 2017

(54) SYSTEM, METHOD AND APPARATUS FOR SIMULTANEOUS MEDIA COLLABORATION

(71) Applicant: Michael J. Fahey, Glastonbury, CT (US)

(72) Inventor: Michael J. Fahey, Glastonbury (YS)

(73) Assignee: Armored Info, LLC, Hartford, CT (US)

(21) Appl. No.: 14/970,804

(22) Filed: Dec. 16, 2015

(51) Int. Cl. G06F 17/30; G06F 3/0484; G06F 21/62; G06F 21/10; H04L 29/06; H04W 4/00

(52) U.S. Cl. CPC G06F 17/30165; H04L 65/1089; H04L 65/1063; H04W 4/008; G06F 21/6218; G06F 21/10; H04L 63/0428; G06F 17/30126; G06F 17/30174; G06F 3/0484; H04L 2209/80; G06F 2221/2111

(57) ABSTRACT

A method, system, and apparatus is disclosed for multiple users and/or groups to curate a single combined media playlist using multiple devices while a single host device is connected to speakers/an output.

### BACKGROUND OF THE INVENTION

Field of the Present Invention

The present invention relates generally to media collaboration, in particular, to a method, system, and apparatus for media collaboration between remotely located users in real time allowing for group curation of media files.

Background of the Related Art

Current proprietary hardware systems are restricted to being able to use one Bluetooth device at a time. SONOS™ created a hardware system that requires their hardware and mobile or software application as well as requires the users to be on the same Wi-Fi network to add songs to a queue. In addition SONOS™ hardware is expensive and limits the end user to have to be in an environment where that hardware is readily available. This limits the number of available areas where a group can curate a playlist. In addition it is a very expensive investment.

As such there exists a need for groups to curate a playlist using multiple devices while a single host device is connected to speakers/an output system.

Additionally, there exists a need for such a system without required proprietary hardware as well as being on the same Wi-Fi network.

### SUMMARY OF THE INVENTION

The present invention includes a system, method and apparatus that enables real time collaboration between multiple users able to cure a playlist. An advantage and feature of the current solution includes avoiding expensive proprietary hardware or be on the same Wi-Fi network. Additionally, a benefit to the customer is an easy to use cheap solution that enables there Bluetooth speakers that they already purchased to support multiple users curating a playlist. This allows the user to spend less money by not buying proprietary hardware.

Some of the key elements required for implementation of the invention are servers, application interfaces, a database, CDN, a mobile device with Bluetooth™/NFC connectivity, and a mobile or software application.

With the present invention any group of people with a Bluetooth™/NFC enabled speakers and a single mobile device enabled with Bluetooth™/NFC can curate a group playlist. This is useful because there are a many Bluetooth™ enabled speakers in use already and people at parties/social gatherings fight to be in control of the music. Now multiple people can add songs to the queue without having to change mobile device connections from a speaker dock or connect/reconnect to a Bluetooth™ enabled device.

In a first embodiment, the present invention includes a system for curating a set of media files between at least two users operating the same connected software application in remote locations, the system comprising a software application having a set of instructions to designate a primary user and at least one secondary user, at least one secure database running the software, the at least one secure database interconnected to a network having access to a public or private internet connection, the software application including a first set of instructions to provide access to the set of media files simultaneously to each of the primary user and the at least one secondary user, such that either of primary user and the at least one secondary user may curate the set of media files in real time, a graphical user interface (GUI) displaying the software application where the GUI is interconnected to the at least one secure database where the set of media files is updated on a real time basis as each of that either of primary user and the at least one secondary user curate the set of media files.

In some embodiments there is a security module structured and arranged to determine the location of each of a primary user and the at least one secondary user in order to selectively restrict access to the set of media files based upon said location.

In some embodiments there is a content delivery network module interconnected to the GUI and the secure database and being the structured and arranged for wireless receipt and storage of curation calls from the primary user and the at least one secondary.

In some embodiments there is an encryption module interconnected to the database and the GUI, said encryption module structured and arranged to provide secure point to point encryption between the primary user and the at least one secondary user.

In some embodiments there is a synchronization application module interconnected to the GUI and the least one secure database, the synchronization application module structured and arranged to synchronize modifications of said file.

In some embodiments the set of media files include pre-recorded audio signals.

In some embodiments the set of media files include pre-recorded video signals.

In some embodiments the security module includes a global position system.

In some embodiments there is a wireless signal connection between each of the primary user and the at least one secondary.

In some embodiments there is a wireless signal connection between, the primary user, the at least one secondary and speaker device.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a schematic illustration of an exemplary computing environment, which is applicable to implement embodiments of the present invention;

FIG. 2 shows a view of a mobile device implementing the application according to one embodiment of the present invention;

FIG. 3 shows another view of a mobile device implementing the application according to one embodiment of the present invention;

FIG. 4 shows another view of a mobile device implementing the application according to one embodiment of the present invention;

FIG. 5 shows another view of a mobile device implementing the application according to one embodiment of the present invention;

FIG. 6 shows another view of a mobile device implementing the application according to one embodiment of the present invention;

FIG. 7 shows another view of a mobile device implementing the application according to one embodiment of the present invention;

FIG. 8 shows another view of a mobile device implementing the application according to one embodiment of the present invention;

FIG. 9 shows another view of a mobile device implementing the application according to one embodiment of the present invention;

FIG. 10A shows another view of a mobile device implementing the application according to one embodiment of the present invention;

FIG. 10B shows another view of a mobile device implementing the application according to one embodiment of the present invention

FIG. 11 shows set of mobile devices implementing the application together in connection with the speaker system according to one embodiment of the present invention;

FIG. 12 shows a flow diagram of FIG. 11 according to one embodiment of the present invention; and

FIG. 13 shows an exemplary communication setup between a server and a client by using a websocket protocol according to one embodiment of the present invention.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

Exemplary Operating Environment

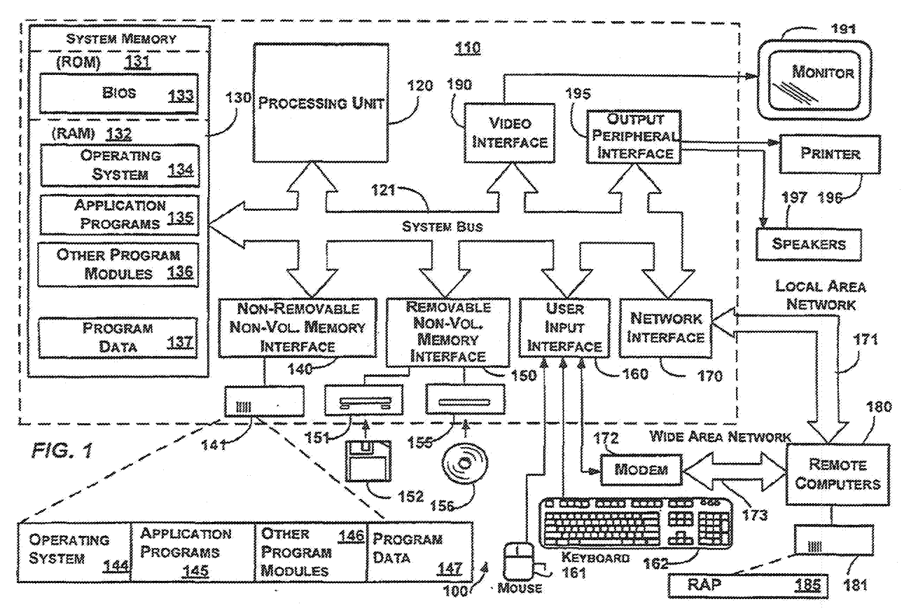

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

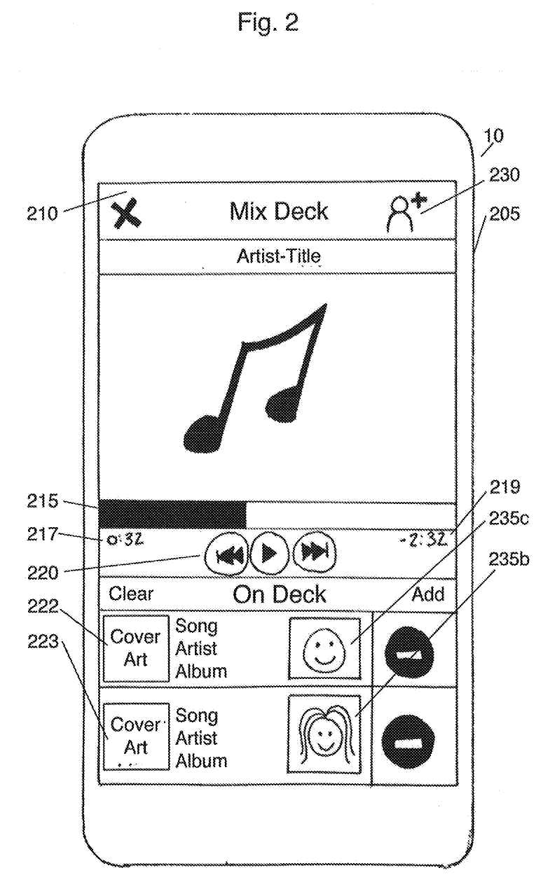

Referring now to FIG. 2, there is shown a mobile device 205 upon which an application 210 which is the subject of the present invention 10 is implemented. A primary user can be set within the application by the user who starts the mix deck application. A temporary group can then be created on the backend with temporary access for additional group users that are assigned by the primary user. The group users on the backend are assigned to the group with a permission to share read only audio assets. Such audio assets are themselves not actually transferred to the primary user (like FTP or file transfer etc.) but the URL that points to where the audio file resides on the CDN is shared to the group on the backend. When a mix deck session is closed out the temporary group is erased along with the temporary permissions and users.

A user will determine to use the mix deck application 210. The mix deck application 210 allows a user to add friends to the mix and add songs to the queue. Files are not physically sent to host device however the host device user has temporary access to the other contributor's files via URL. The user may close the mix deck application 210 by tapping or clicking the X “button” and the application will close if there are no other friends that are part of the mix. If there are friends that are part of the mix and the user clicks button 230 to add them. Application 210 may include time line 215 with time elapsed 217 and time left 219 monikers. Buttons 220 include play, fast forward, fast reverse, pause and stop, accordingly. Sections 220 and 223 show potential additional users that may collaborate with mix deck application 210 curation process 10 and include pictures 235a and 235b allowing a primary users to identify the group members.

Clicking the yes button will display the view below. Clicking no will take the user back to the mix. If they click minimize to navigation bar (“nav bar”) they will be returned to their account home page. The user will then be removed from the group's member's view in the mix deck administrator's view. To add them back into the mix they have to add them to mix members again.

Clicking Play/Pause Button will play or pause the current song in mix deck. Clicking the Previous Song Button < will take the user to the previous song in the mix. If there is not a previous song then the button does not do anything. Clicking the Next Song Button > will take the user to the next song in the mix. If there is not a song next then the button does not do anything. Clicking the Clear Button will clear the queue of songs. The user/group will be prompted with a message accordingly. Clicking “Yes” will clear the queue and close the dialog. Clicking “No” will not clear the queue and close the dialog.

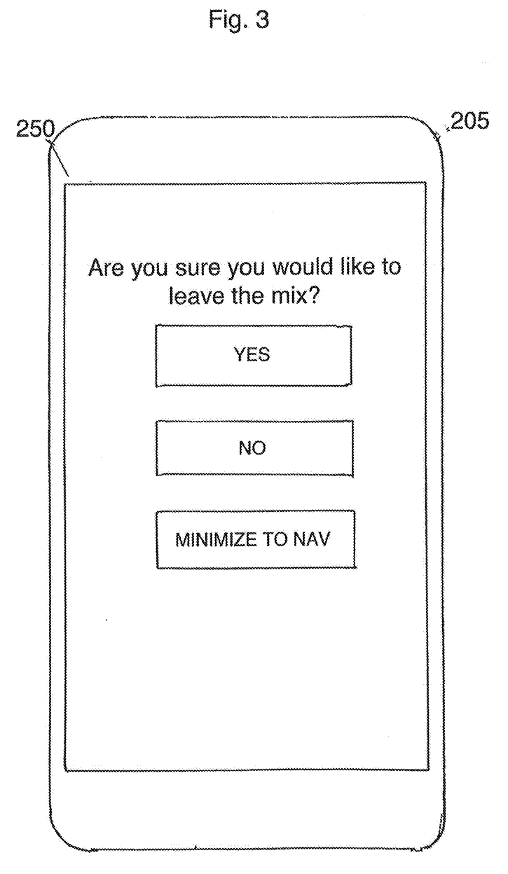

FIG. 3 shows mobile device 210 and application 210 displaying query 250 upon the primary user clicking X from FIG. 2. When a user clicks to minimize to nay bar the album artwork will be displayed where the media player is with the words MIX below. The takes the place of the media player. A user can then navigate around there account while the mix is going on. To return to the mix deck they simply open up the nav and click the album artwork or MIX text.

Clicking the Add Friends (+) button is displayed where a user can select from their friends list people to add to the mix. When a user clicks the + button on a friend the friend is added to mix members and the icon changes to a − button. Clicking the − button will remove the user from the mix members. Once the user clicks OK all additions of friends or removal of friends is saved and the user is returned to the view seen in the first image. If a user was added to the mix deck a mix invite is sent to that user's mobile device.

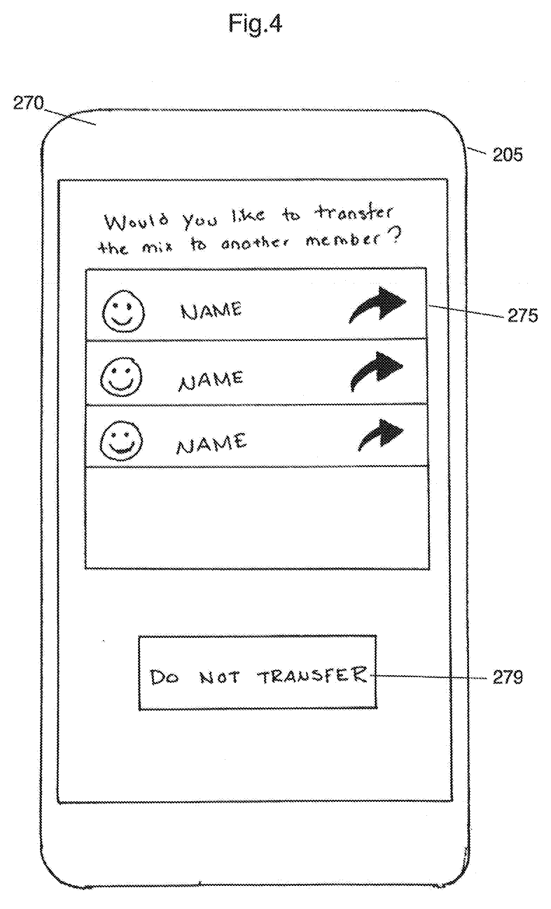

FIG. 4 shows mobile device 205 and application 210 displaying page 270 upon the primary user clicking the add friends button 230 from FIG. 2 (the invite process). Potential additional friends 270 are shown along with a do not transfer option 279. The user can then choose to transfer mix deck control to another member of the mix. Clicking the arrow will give that member control of the mix and then take the user to media library or project library view. If they choose do not transfer then the mix will be closed and admin and users within the mix will be taken to their account. Files are not actually sent to host device. Host device user has temporary access to contributors files via URL.

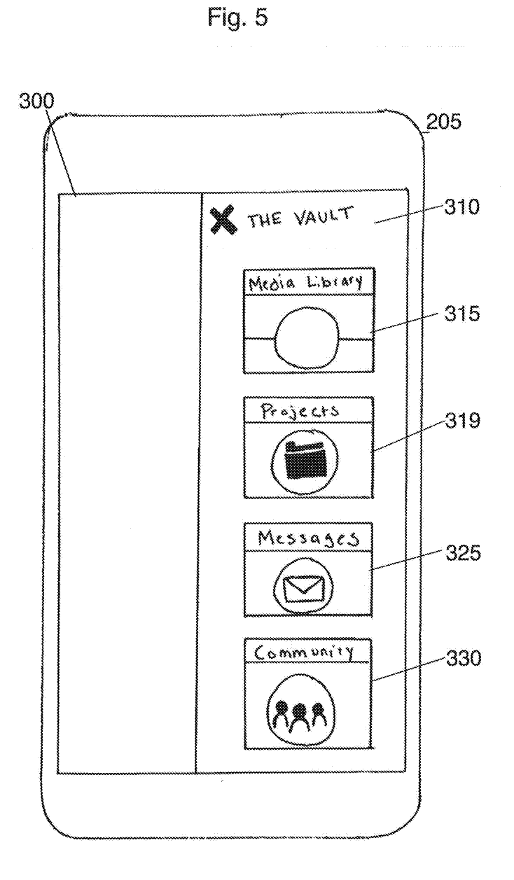

FIG. 5 shows mobile device 205 and application 210 displaying page 200 which is the vault 310, having a media library 315, project list 319, messages tab 325 and community tab 330.

The system 10 can automatically send an email to the mix deck group members when mix deck session is ended listing the songs played in the mix that were purchased from a marketplace.

Some embodiment can include a marketplace portal showing current playlist and marketplace details with a shopping cart icon that allows a group member to individually purchase the media file.

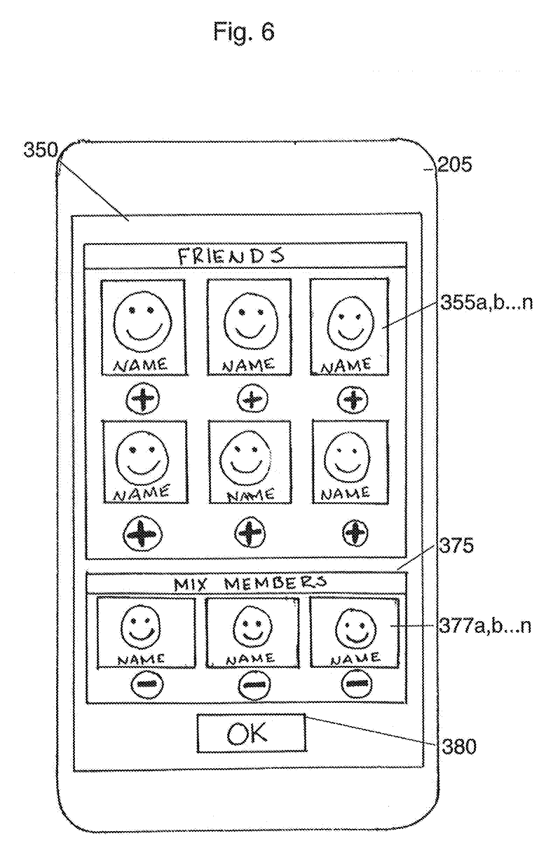

FIG. 6 shows mobile device 205 and application 210 displaying page 350 showing friends 355a, 355b . . . 355n. Section 375 shows members of a mix group 377a, 377b 377n with accept button 380 for adding addition friends to the group 375.

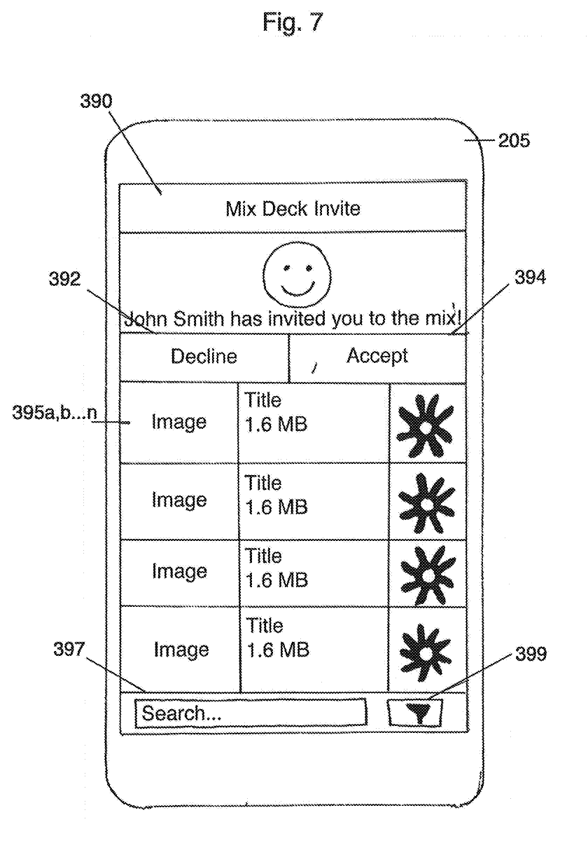

FIG. 7 shows mobile device 205 and application 210 displaying page 390 which is a mix deck invite. Invite 390 includes decline button 392 and accept button 394 as well tabs 395a, 395b . . . 395n identifying various media files to be added to the mix deck application 210 list. There is also a search filed 397 present along with filter icon button 399 which allows a user to sort by song title and album tile, ascending to descending or descending to ascending (A-Z, Z-A,).

If a user clicks accept then they will be taken to the mix deck view. If the user clicks decline they will not be taken to the mix deck and the invite overlay will disappear. Until a user makes a choice the notice does disappear. If a user declines then the user is removed from the mix members view seen by the mix deck admin. The user will be placed back into the friends list.

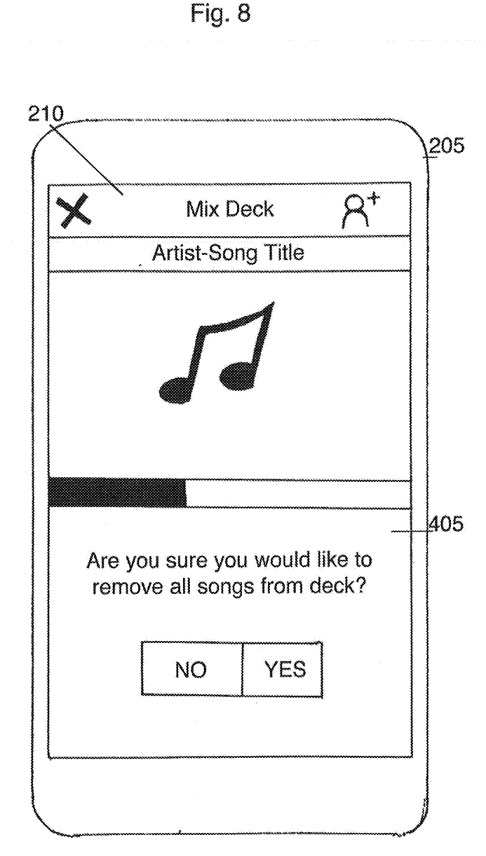

FIG. 8 shows mobile device 205 and application 210 displaying delete function 405. Clicking Remove Song From Queue (−) button will remove the song from the queue. If an admin or mix member has not added songs to the mix they will see No Songs added to queue error message.

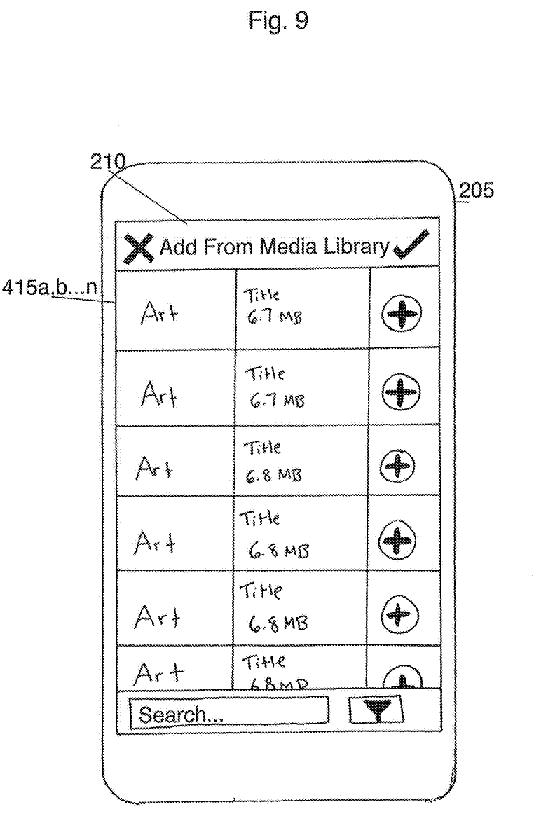

FIG. 9 shows mobile device 205 and application 210 displaying media library 315 listing media files 315a, 315b . . . 315n. Clicking this button will display the “add” feature from media library view. A user can select songs to add to the queue from this view. Clicking the check mark will confirm all songs will be added to the queue. Clicking the X will not save selections and close the “add” from media library view and return the user to the mix deck.

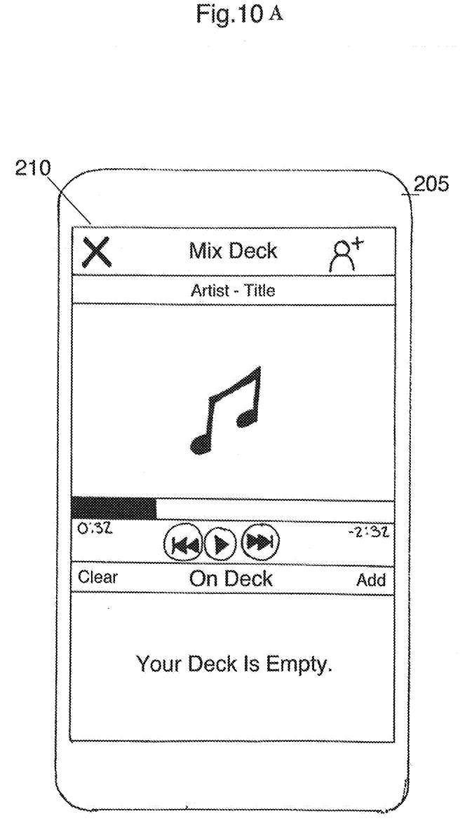

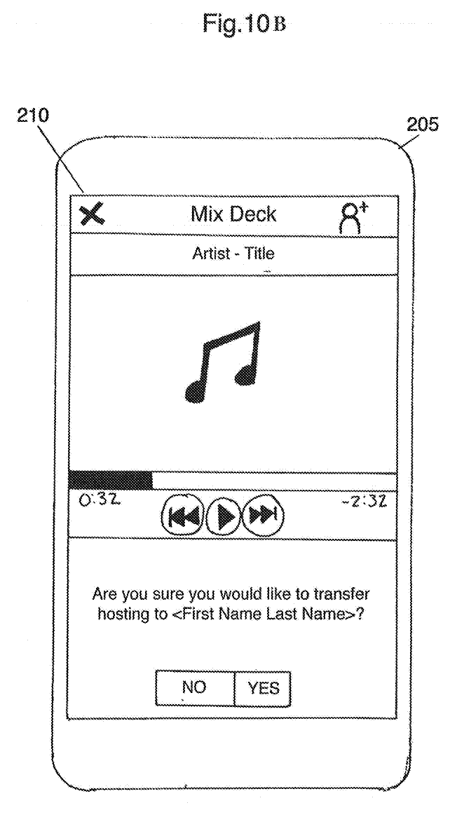

FIG. 10A shows mobile device 205 and application 210 displaying an empty deck.

FIG. 10B shows mobile device 205 and application 210 displaying a transfer hosting query 450. If the mix deck host wants to transfer hosting to another member of the mix without leaving the mix entirely they click the persons profile picture. The user is then prompted accordingly, and has the option of clicking a “Yes” Button which will transfer hosting to user and close overlay and treat user like a member of the mix deck and not the host. Clicking the “No” Button will not transfer hosting to user and close overlay.

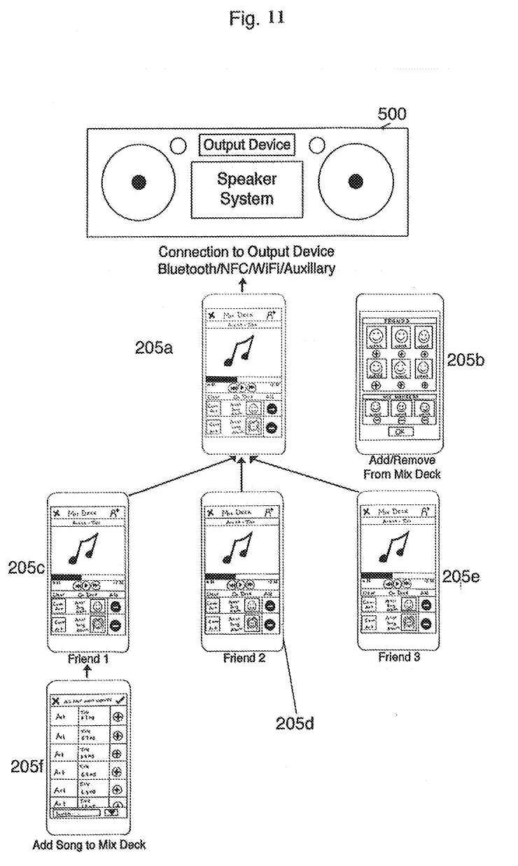

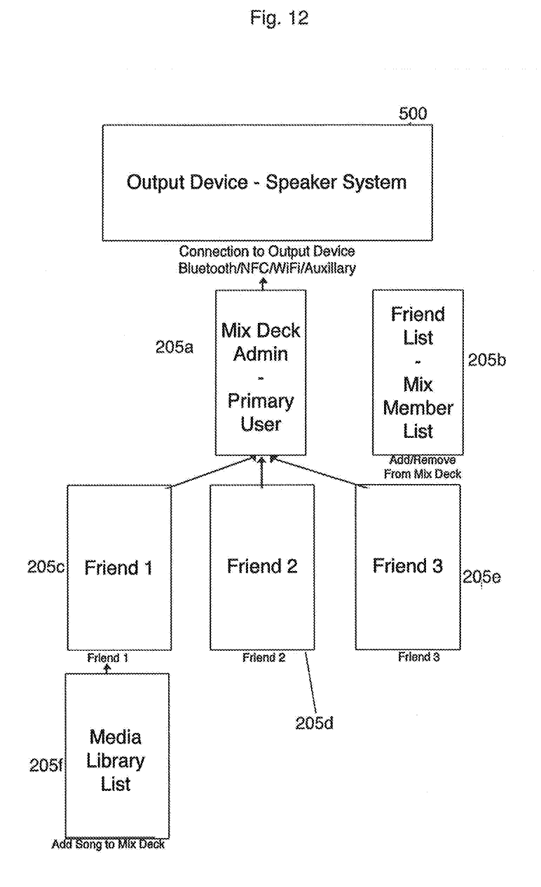

FIGS. 11 and 12 show alternative schematic overviews of invention 10 showing mobile devices, 205a-205f along with output device 500 having connection (wireless or hard wired) to mobile devices 205.

When a song is added to the mix deck by a user the file is not actually sent to the mix deck admin. A temporary access link from the CDN is given to be able to play that song from the user's account on the mix deck admin's device.

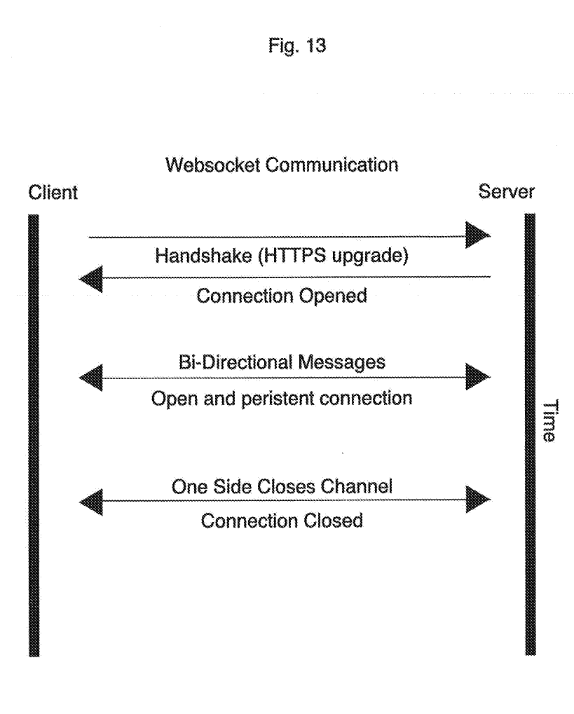

FIG. 13 shows an exemplary communication setup between a server and a client by using a websocket protocol according to one embodiment of the present invention. The mobile device itself would connect to the interne by mobile carrier network and use the individuals data plan or over Wi-Fi.

It will be apparent to one of skill in the art that described herein is a novel system and method for group curating of media files. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

What is claimed is:

1. A system for curating a set of media files between at least two users operating the same connected software application in remote locations, the system comprising a software application having a set of instructions to designate a primary user and at least one secondary user, at least one secure database running the software, the at least one secure database interconnected to a network having access to a public or private internet connection, the software application including a first set of instructions to provide access to said set of media files simultaneously to each of the primary user and the at least one secondary user, such that either of primary user and the at least one secondary user may curate the set of media files in real time, a graphical user interface (GUI) displaying said software application where the GUI is interconnected to the at least one secure database where said set of media files is updated on a real time basis as each of that either of primary user and the at least one secondary user curate the set of media files.

2. The system according to claim 1 further comprising a security module structured and arranged to determine the location of each of a primary user and the at least one secondary user in order to selectively restrict access to said set of media files based upon said location.

3. The system according to claim 1 further comprising a content delivery network module interconnected to the GUI and the secure database and being the structured and arranged for wireless receipt and storage of curation calls from the primary user and the at least one secondary.

4. The system according to claim 1 further comprising an encryption module interconnected to the database and the GUI, said encryption module structured and arranged to provide secure point to point encryption between the primary user and the at least one secondary user.

5. The system according to claim 1 further comprising a synchronization application module interconnected to the GUI and the least one secure database, the synchronization application module structured and arranged to synchronize modifications of said file.

6. The system according to claim 1 where said set of media files include pre-recorded audio signals.

7. The system according to claim 6 where said set of media files include pre-recorded video signals.

8. The system according to claim 2 where the security module includes a global position system.

9. The system according to claim 1 further comprising a wireless signal connection between each of the primary user and the at least one secondary.

10. The system according to claim 1 further comprising a wireless signal connection between, the primary user, the at least one secondary and speaker device.
